(19) United States
(12) Patent Application Publication
(10) Pub. No.: US 2026/0110255 A1
(43) Pub. Date: Apr. 23, 2026

(54) INTEGRATED ONCE THROUGH COOLER WATER AND STEAM SHARING SYSTEM FOR MULTI-UNIT GAS TURBINE COMBINED CYCLE POWER BLOCKS

(71) Applicant: ACWA POWER Company, Riyadh (SA)

(72) Inventors: Jalal Hunain ZIA, Dubai (AE); Ronald ABBAS, Dubai (AE); Muhammad Adnan SAROOSH, Jeddah (SA)

(73) Assignee: ACWA POWER Company, Riyadh (SA)

(21) Appl. No.: 19/362,372

(22) Filed: Oct. 18, 2025

Related U.S. Application Data
(60) Provisional application No. 63/709,025, filed on Oct. 18, 2024.

(51) Int. Cl. F01K 23/10; F01K 7/16; F01K 9/00; F22B 1/18; F22B 35/18; F22D 1/00; F22G 1/16

(52) U.S. Cl. CPC F01K 23/10; F01K 7/16; F01K 9/00; F22B 1/1815; F22B 35/18; F22D 1/003; F22G 1/16

(57) ABSTRACT

A power plant system includes a set of gas turbines with a first gas turbine and a second gas turbine operating. The first gas turbine and the second gas turbine are configured to generate energy. The power plant system includes a first OTC unit associated with the first gas turbine, where steam is supplied from the first OTC unit. The power plant system includes a second OTC unit associated with the second gas turbine, where steam is supplied from the second OTC unit. Further, the power plant system includes a HRSG unit associated with a second gas turbine, where the steam is supplied to the HRSG unit from the first OTC unit and the second OTC unit to generate specific steam. The power plant system includes a set of steam turbines generates energy based on a supply of the specific steam from the HRSG unit to the set of steam turbines.

### CROSS-REFERENCE TO RELATED APPLICATION

This application claims priority to U.S. Provisional Patent Application Ser. No. 63/709,025, filed Oct. 18, 2024 and entitled APPARATUS AND METHOD FOR STEAM SHARING IN GAS TURBINES USING HEAT RECOVERY STEAM GENERATOR, the disclosure which is incorporated herein by reference.

### TECHNOLOGICAL FIELD

The present invention generally relates to power generation and more particularly relates to combined-cycle power generation and, more particularly, to systems and methods that enable the exchange of once-through-cooler (OTC) water and steam flows among multiple gas-turbine/heat-recovery-steam-generator (HRSG) units operating in different modes within one or more power blocks.

### BACKGROUND

Gas turbines with high efficiency, quick start-up capabilities, and a modular design are widely used for power generation. The gas turbines operate on principles of thermodynamics, primarily converting chemical energy obtained from burning fuel into mechanical energy, and further, the mechanical energy is converted into electrical energy. The gas turbines are utilized across multiple industries for diverse applications, which include, but are not limited to, the aviation industry for jet propulsion, the power generation industry for generating electricity, and the oil and gas industry for driving compressors and pumps or for on-site power generation.

Conventionally, the gas turbines work in two operating modes, for example, a combined cycle mode and an open cycle operating mode (interchangeably known as an open cycle mode or “OC”, herein). In the open cycle operating mode, a gas turbine cycle is used for power generation. In the open cycle operating mode, the gas turbines intake ambient air and compress the ambient air in a compressor unit of the gas turbine. Further, the compressed ambient air is mixed with the fuel in the combustion chamber. Furthermore, an igniter associated with the combustion chamber is configured to initiate the combustion of the fuel and the compressed ambient air to generate exhaust gas at a high temperature and high pressure. After initiation of combustion, the combustion is self-supporting, whereby the fuel and air mixture auto ignites in the existing flames. In many modern gas turbines, a small part of compressed air is extracted from the compressor unit and cooled through indirect heat exchange with high-pressure water (for example, 200 bars) in a once-through cooler arrangement. Upon cooling, the compressed air is directed to the gas turbine, and the compressed air is used to cool at least one of the rotating parts of the gas turbine and the turbine air cavities of the gas turbine. The once-through cooler arrangement generates superheated steam when the high-pressure water encounters hot compressed air. In the open cycle operating mode, the associated HRSG is isolated, and the generated steam is transferred to a dump condenser unit to condense the generated steam into water, and the water is pumped back to a once-through cooler (OTC) unit. When the generated steam is condensed into the water, heat is lost from the generated steam. Further, the lost heat is released into the environment, and the lost heat is also referred to as wasted heat (also known as potentially useful heat, herein). The lost heat represents potential useful energy that is otherwise wasted in the open cycle operating mode. Thus, the gas turbine cycle results in a loss of useful heat during the open cycle operating mode.

On the contrary, in the combined cycle operating mode, the gas turbine cycle and a steam cycle are used for power generation. In the combined cycle operating mode, the steam produced within the OTC unit is fed back to a heat recovery steam generator (HRSG) unit. For example, the feedwater is supplied from the HRSG unit to the OTC unit. Further, the compressor unit supplies high-temperature and high-pressure extracted compressed air to the OTC unit. The OTC unit absorbs heat from the extracted compressed air to generate steam within the OTC unit. Power generation plant(s) commonly employ the gas turbines, which operate in the open cycle operating mode as well as the combined cycle operating mode when an associated HRSG is present downstream of the gas turbine. In the existing configuration of the open cycle operating mode, waste heat from steam at high-temperature and high-pressure generated within the OTC unit goes unutilized.

Currently, there is no reliable mechanism for enabling the utilization of waste heat generated in the OTC in the open cycle operating mode. To address the existing challenges, various techniques have been implemented to utilize the heat from the generated steam in the open cycle operating mode. However, the existing techniques have primarily focused on simple heat recovery through one or more heat exchangers, lacking the ability to effectively utilize the thermal energy of the steam.

### SUMMARY

The present invention generally relates to power generation and more particularly relates to systems and methods that enable the exchange of once-through-cooler (OTC) water to generate steam flows among multiple gas-turbine/heat-recovery-steam-generator (HRSG) units operating in different modes within one or more power blocks.

In one aspect, a power plant system includes a set of gas turbines. The set of gas turbines includes a first gas turbine operating in an open cycle mode and a second gas turbine operating in a combined cycle mode, where the first gas turbine and the second gas turbine are configured to generate energy. Further, the power plant system includes a first once-through cooling (OTC) unit associated with the first gas turbine, where steam is generated from the first OTC unit. Further, the power plant system includes a second once-through cooling (OTC) unit associated with the second gas turbine, where steam is generated from the second OTC unit. Further, the power plant system includes a heat recovery steam generator (HRSG) unit associated with the second gas turbine, where the steam is supplied to the HRSG unit from the first OTC unit and the second OTC unit to generate specific steam. Further, the power plant system includes a set of steam turbines that generates energy based on a supply of the specific steam from the HRSG unit to the set of steam turbines.

Further features and advantages will become apparent from the following detailed description when taken in conjunction with the accompanying drawings.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a diagram that illustrates an exemplary block diagram of a power plant system operating in a combined cycle mode within one or more power blocks, in accordance with an embodiment of the present disclosure;

FIG. 2A is a diagram that illustrates an exemplary block diagram of a first gas turbine operating in an open cycle operating mode, in accordance with an embodiment of the present disclosure;

FIG. 2B is a diagram that illustrates another exemplary block diagram of the second gas turbine operating in the combined cycle operating mode, in accordance with an embodiment of the present disclosure;

FIG. 2C is a diagram that illustrates an exemplary block diagram of the power plant system, where the first gas turbine is operating in the open cycle mode, and the second gas turbine 108 is operating in the combined cycle mode within one or more power blocks, in accordance with the present disclosure;

FIG. 3 is a diagram that illustrates an exemplary call flow diagram of a power plant system operating in a combined cycle mode within one or more power blocks, in accordance with an embodiment of the disclosure; and

FIG. 4 illustrates a flowchart of an exemplary method of operating a power plant system, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in the form of block diagrams to avoid obscuring the present disclosure.

Some embodiments of the present disclosure will now be described fully hereinafter with reference to accompanying drawings, in which some, but not all, embodiments of the disclosure are shown. Indeed, various embodiments of the disclosure may be embodied in different forms and should not be construed as limited to the embodiments set forth herein; rather, these embodiments are provided so that the present disclosure may satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all referring to the same embodiment, nor are separate or alternative embodiments mutually exclusive of other embodiments. Further, the terms “a” and “an” herein do not denote a limitation of quantity but rather denote presence of at least one of the referenced items. Moreover, various features are described, which may be exhibited by some embodiments and not by others. Similarly, various requirements are described which may support requirements of some embodiments in the disclosure, but not for the rest of the embodiments.

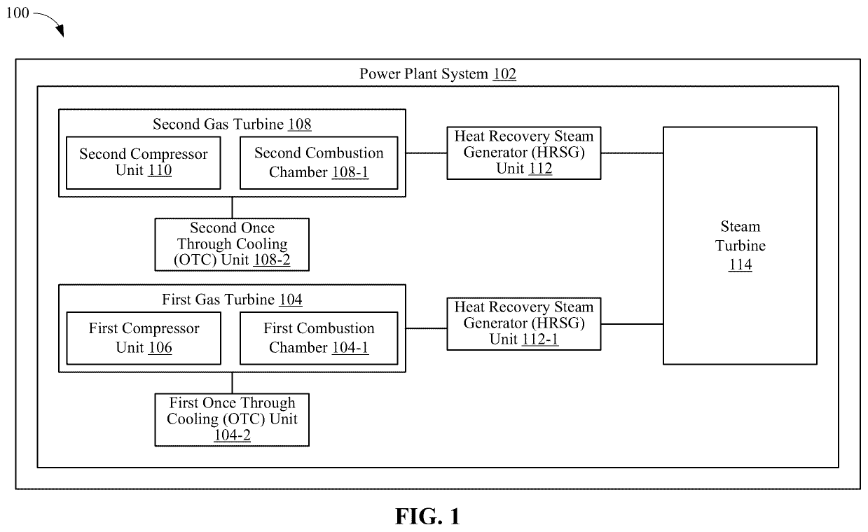

The embodiments are described herein for illustrative purposes and are subject to many variations. It is understood that various omissions and substitutions of equivalents are contemplated as circumstances may suggest or render expedient but are intended to cover the application or implementation without departing from spirit or scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 5, a brief description concerning the various components of the present disclosure will now be briefly discussed. Reference will be made to the figures showing various embodiments of an apparatus for steam sharing in gas turbines using an HRSG unit.

The power generation plant(s) employ the gas turbines, which are a type of internal combustion engine that burns fuel, such as natural gas, to generate combustion product gas at high temperature and high pressure. For example, the high temperature may range from 2192° F. (degrees Fahrenheit) to 3100° F., and the high pressure which is typically 20 to 40 bar and may reach up to 60 bar for advanced gas turbines classes. The combustion product gas rapidly expands, which enables one or more turbine blades to drive the gas turbine generator of the power generation plant. The gas turbines operate in the open cycle operating mode as well as the combined cycle operating mode. During the operation of the internal combustion engine, a large amount of waste heat is also released as hot exhaust gas. The exhaust gas is typically high temperature and low pressure. For example, the high temperature exhaust gas may range from 1022° F. to 1202° F. and the low pressure which may range between 1.03 bar to 1.2 bar.

The present disclosure addresses the unutilized waste heat generated in a gas turbine Once Through Cooler (OTC) while operating in the open cycle mode. The energy captured in OTC of open cycle gas turbine is wasted in dump condenser. The unutilized waste heat generated from the OTC when the gas turbine is in open cycle presents a complex challenge that if utilised effectively with cost-effective solutions can significantly improve energy yield and profitability of the power generation plants. Therefore, understanding and enabling the utilization of waste heat generated in the open cycle operating mode, thereby improving the efficiency of the power generation plant, is crucial for generating electrical energy more efficiently.

Existing solutions, such as a combined cycle gas turbine (CCGT), may be configured to route the hot exhaust gas through a Heat Recovery Steam Generator (HRSG) to produce steam for the generation of electricity. Further, the CCGT utilizes the heat from the steam generated within the OTC unit to generate superheated steam. However, if the CCGT and the open cycle gas turbine are operating together within a power block, then this configuration does not specifically address the unutilized waste heat in the OTC of Gas Turbine operating in open cycle. Thus, the existing solutions increase the overall complexity of the power plant.

Therefore, the proposed power plant system may provide a reliable and effective approach to maximize the recovery of thermal energy in the power generation plant for the generation of electrical energy. The proposed apparatus may allow the conversion of waste heat from OTC open cycle gas turbine to generate steam for driving a set of steam turbines to generate additional electrical power. Further, the proposed power plant system may utilize the heat from the steam generated within the OTC units to generate superheated steam, which is further utilized for the operation of the set of steam turbines. The proposed apparatus may enable quicker response to load changes and varying energy demands.

Further, the proposed power plant system may utilize the waste heat, which in turn reduces the consumption of fuel. Thus, an improved fuel economy is achieved, and significant reductions in carbon dioxide (CO2) and other emissions from the power generation plant are exhibited. Further, the proposed apparatus may distribute a thermal load and a mechanical load to reduce the stress on the OTC unit and the HRSG unit.

Furthermore, the proposed power plant system may provide a multi-stage combustion which adds waste heat to a thermodynamic cycle, allowing for higher efficiency, increased power, and enhanced emission control, particularly for large industrial gas turbines. The proposed power plant system may capture heat from extracted air through a set of compressor units associated with the set of gas turbines to produce steam to drive the set of steam turbines for additional electricity generation. The overall efficiency of the power generation plant, often reaching efficiencies of 55-64%, is higher when compared to the power generation plant operating using the conventional steam cycles. Further, the proposed power plant system allows the power generation plant to operate in various configurations, which include, but are not limited to, an open cycle, a combined cycle and combination of open and combine cycle to match changing grid demands, seasonal variations, and operational needs of a power generation facility.

FIG. 1 is a diagram that illustrates an exemplary block diagram of a power plant system 102 operating in a combined cycle mode within one or more power blocks, in accordance with an embodiment of the present disclosure. In FIG. 1, a block diagram 100 of the power plant system 102 for steam sharing in the gas turbines using the heat recovery steam generator is shown. The block diagram 100 includes the power plant system 102, a first gas turbine 104, a first combustion chamber 104-1, a first once-through the first (OTC) unit 104-2, a first compressor unit 106, a second gas turbine 108, a second combustion chamber 108-1, a second once-through the first (OTC) unit 108-2, a second compressor unit 110, an HRSG unit 112, an HRSG unit 112-1, and a set of steam turbines 114. The power generation plant may utilize a set of gas turbines to generate energy. The set of gas turbines may include the first gas turbine 104 and the second gas turbine 108. For example, the power generation plant may correspond to a natural gas-fuelled power plant.

Further, the set of gas turbines may be widely used for the generation of exhaust energy, as the set of gas turbines is highly efficient and incorporates a quick start-up capability. Typically, the set of gas turbines may utilize fuel and compressed air for the combustion of the fuel to generate energy. The first compressor unit 106 receives air from the environment through an air filtration unit. In an embodiment, the first compressor unit 106 may be within the first gas turbine 104. Further, the received air may be compressed by the first compressor unit 106, and the compressed air may be directed to the first combustion chamber 104-1 associated with the first gas turbine 104. The compressed air may be mixed with fuel (for example, natural gas) and ignited in the first combustion chamber 104-1. As a result of ignition, the exhaust gas is generated in the first combustion chamber 104-1 and transferred to the HRSG unit 112. Correspondingly, the received air may be compressed by employing the second compressor unit 110 within the second gas turbine 108. Further, the compressed air may be directed to the second combustion chamber 108-1 associated with the second gas turbine 108. The compressed air may be mixed with the fuel, and the fuel is ignited in the second combustion chamber 108-1. As a result of ignition, the exhaust gas is generated in the second combustion chamber 108-1 and transferred to the HRSG unit 112.

Furthermore, the exhaust gas is expanded and directed to a set of blades associated with the first gas turbine 104 and a set of blades associated with the second gas turbine 108, respectively, causing the set of blades to rotate. The first gas turbine 104 and the second gas turbine 108 may be associated with the set of steam turbines 114 via the HRSG unit 112. The set of steam turbines 114 may be configured to convert mechanical energy to generate electrical energy. Further, the first OTC unit 104-2 and the second OTC unit 108-2 generate steam by using the heat from extracted compressed air received from the first compressor unit 106 and the second compressor unit 110, respectively. The exhaust gas of the first gas turbine 104, is released to the atmosphere. The exhaust gas of the second gas turbine is directed to the HRSG unit 112.

The HRSG unit 112 and the HRSG unit 112-1 may typically be fixed downstream of the set of gas turbines within the power generation plant. Within the power generation plant, the exhaust gas from the second gas turbine is discharged to the HRSG unit 112. The exhaust gas may be used by the HRSG unit 112 to generate steam. Further, the generated steam is used to drive the set of steam turbines 114 to generate energy. The HRSG unit 112 may be configured to recover waste heat from the exhaust gas to generate steam and supply the steam to the set of steam turbines 114.

The set of steam turbines 114 may be configured to generate energy based on the steam supplied from the HRSG unit 112. The HRSG unit 112 may recover heat from the exhaust gas which are generated from the second gas turbine. The HRSG unit 112 utilizes the heat to generate a specific steam. Specifically, the specific steam may correspond to the steam that may be generated by the HRSG unit 112. The specific steam may be directed from the HRSG unit 112 to the set of steam turbines 114 through a set of nozzles. The set of nozzles is associated with the set of steam turbines 114, where the set of nozzles may be configured to convert thermal energy and pressure energy of the specific steam into kinetic energy by increasing the velocity of the specific steam. Further, the set of nozzles may be configured to direct the specific steam onto a set of turbine blades associated with the set of steam turbines 114. The thermal energy of the received specific steam is efficiently converted into mechanical energy. Further, the power plant system 102 may be configured to utilize the heat from the HRSG unit 112 to significantly enhance the overall efficiency of the power plant system 102.

In operation, the power plant system 102 may include the set of gas turbines including the first gas turbine 104 operating in the open cycle mode and the second gas turbine 108 operating in the combined cycle mode. The first gas turbine 104 and the second gas turbine 108 are configured to generate energy. Further, the power plant system 102 may include a first once-through cooling (OTC) unit (not shown in FIG. 1) associated with the first gas turbine 104, where steam is supplied from the first OTC unit. Furthermore, the power plant system 102 may include a second once-through cooling (OTC) unit (not shown in FIG. 1) associated with the second gas turbine 108, where steam is supplied from the second OTC unit.

In an embodiment, the power plant system 102 may further include the HRSG unit 112 associated with the second gas turbine 108. The power plant system 102 includes the first gas turbine associated with HRSG unit 112-1. In an embodiment, the HRSG unit 112-1 is associated with the set of steam turbines 112. The steam is supplied to the HRSG unit 112 from the first OTC unit and the second OTC unit to generate specific steam. Further, the power plant system 102 may include the set of steam turbines 114 to generate energy based on a supply of the specific steam from the HRSG unit 112 to the set of steam turbines 114.

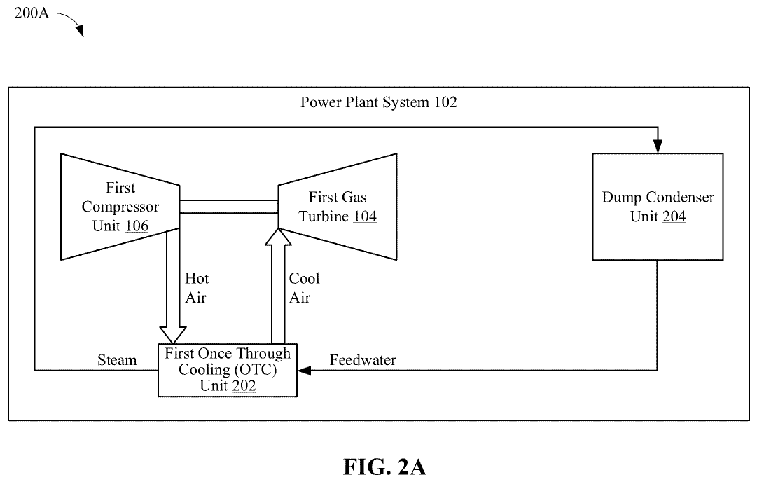

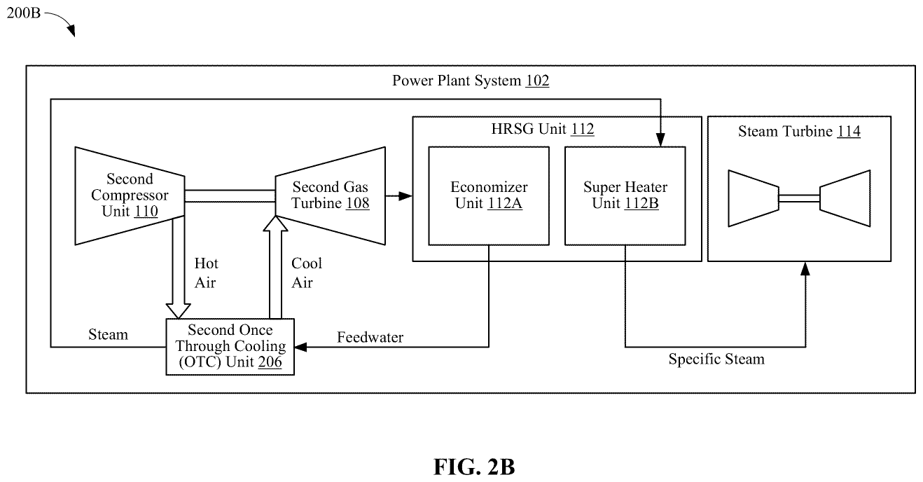

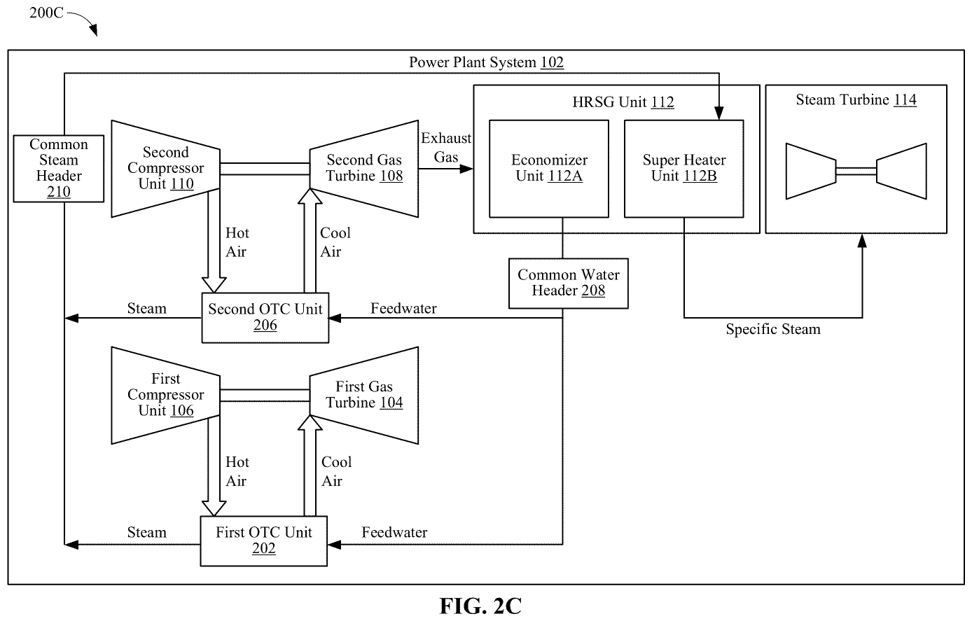

FIG. 2A is a diagram that illustrates an exemplary block diagram 200A of the first gas turbine operating in an open cycle operating mode, in accordance with an embodiment of the present disclosure. In FIG. 2A, there is shown an exemplary block diagram 200A of the power plant system 102 for power generation in an open cycle operating mode. Elements of FIG. 2A is explained in conjunction with the elements of FIG. 1. The power plant system 102 for power generation in the open cycle operating mode may include the first gas turbine 104, the first compressor unit 106, a first once-through the first (OTC) unit 202, and a dump condenser unit 204.

In an embodiment, the power plant system 102 may generate energy by the first gas turbine 104 in the open cycle operating mode. In an embodiment, the first gas turbine 104 may be coupled with the first compressor unit 106. The first gas turbine 104 may be a sophisticated array of alternate stationary and rotating aerofoil-section blades that may expand hot combustion air received from the first compressor unit 106 integrated therewith.

In the open cycle operating mode, the air may be received into the first compressor unit 106 through the air filtration unit, where the first compressor unit 106 is configured to compress the air. Further, the air filtration unit may be configured to remove dust particulates from the received air. Further, the air is compressed by the first compressor unit 106.

In an embodiment, the power plant system 102 may supply the extracted compressed air from the first compressor unit 106 to the first OTC unit 202. The air supplied from the first compressor unit 106 to the first OTC unit 202 may correspond to extracted compressed air. The extracted compressed air may be continuously passed from the first compressor unit 106 to the first OTC unit 202. In an embodiment, the first OTC unit 202 may include a high-pressure (HP) air-cooling exchanger (HPAC) and a low-pressure air-cooling exchanger (LPAC). In the first OTC unit 202, the process of cooling of the extracted compressed air, which is at high temperature and high pressure, involves passing the extracted compressed air through the HPAC. Further, the extracted compressed air is then cooled in the LPAC before being discharged from the first OTC unit 202. During the process of cooling down the extracted compressed air within the first OTC unit 202, the power plant system 102 may generate the steam within the first OTC unit 202. Further, the power plant system 102 may supply the steam from the first OTC unit 202 to the dump condenser unit 204. The dump condenser unit 204 may be a type of heat exchanger that may be used in the power generation plant and industrial facilities to handle sudden surges or excess steam. The primary function of the dump condenser unit 204 may be to safely condense the steam supplied from the first OTC unit 202. The power plant system 102 may control the dump condenser unit 204 to generate feedwater from the supplied steam from the first OTC unit 202 by applying one or more condensation techniques to the received steam from the first OTC unit 202. The type of dump condenser unit 204 may be, for example, but not limited to, a shell dump condenser unit, a tube dump condenser unit, and an evaporative type dump condenser unit.

While in operation, the dump condenser unit 204 may be employed to condense the generated steam, converting the supplied steam back into the feedwater and supply the feedwater to the first OTC unit 202. The dump condenser unit 204 (also referred to as a condenser unit) may use, for example, but is not limited to, a water-cooling mechanism or an air-cooling mechanism to condense the supplied steam from the first OTC unit 202. For example, the feedwater from the dump condenser unit 204 (the condenser unit) may be collected for reuse, thereby enhancing the environmental efficiency and operational efficiency of the first gas turbine 104. In another example, the generated feedwater from the dump condenser unit 204 may be reused. In an embodiment, the generated feedwater may be sent back to the first OTC unit 202 associated with the first gas turbine 104, creating a recirculating loop.

However, the power plant system 102 for power generation operating in the open cycle operating mode utilizes the first OTC unit 202 and the dump condenser unit 204. The heat removed by the dump condenser unit 204 can be considered lost heat that does not participate in generating motive power in the first gas turbine 104. To utilize the heat dissipated in the environment and reduce the loss of waste heat, the generated steam from OTC is directed to the super heater of the second gas turbine's HRSG operating in the combined cycle mode may be implemented. The details about the combined cycle operating mode are provided, for example, in FIG. 2B.

FIG. 2B is a diagram that illustrates another exemplary block diagram 200B of the second gas turbine operating in the combined cycle operating mode, in accordance with an embodiment of the present disclosure. In FIG. 2B, there is shown an exemplary block diagram 200B of the power plant system 102 for power generation implemented in the combined cycle operating mode. Elements of FIG. 2B are explained in conjunction with the elements of FIG. 1, and FIG. 2A. The power plant system 102 may include the second gas turbine 108, the second compressor unit 110, a second OTC unit 206, the HRSG unit 112, and the set of steam turbines 114. The HRSG unit 112 may further include an economizer unit 112A and a superheater unit 112B.

The second gas turbine 108 operates efficiently in the combined cycle mode. The combined cycle mode leads to the recovery of waste heat for additional power generation. In an embodiment, the power plant system 102 may be configured to control the second gas turbine 108 to generate energy in the combined cycle operating mode. For example, the received air may be compressed by employing the second compressor unit 110 present within the second gas turbine 108, thereby enhancing the efficiency of the combustion process.

While in operation, the power plant system 102 may be configured to supply of the extracted compressed air from the second compressor unit 110 to the second OTC unit 206. After supplying the compressed air through the second OTC unit 206, the power plant system 102 may supply of the steam generated within the second OTC unit, from the second OTC unit 206 to the HRSG unit 112. The steam is generated within the second OTC unit 206 due to an exchange of heat from the extracted compressed air to the feedwater present within the second OTC unit 206. The HRSG unit 112 may be configured to recover heat from the exhaust air of the second gas turbine 108 and use the supplied steam to generate an additional specific steam, which may be utilized to drive the set of steam turbines 114 for additional power generation or other industrial purposes.

In an embodiment, the HRSG unit 112 may receive the exhaust gas from the second gas turbine 108, and the steam from the second OTC unit 206. Thereafter, the heat from the exhaust gas is transferred to heat transfer fluid (such as the feedwater or the steam) within a superheater unit 112B associated with the HRSG unit 112.

Further, the HRSG unit 112 may include the economizer unit 112A to receive heat from the exhaust gas from the second gas turbine 108. Further, the economizer unit 112A may transfer the extracted heat to feedwater associated with the economizer unit 112A, and the transferred extracted heat increases the temperature of the feedwater from a first temperature value to a second temperature value. The economizer unit 112A may transfer the feedwater at the second temperature value to a common water header (not shown in FIG. 2B) associated with at least the first OTC unit 202 and the second OTC unit 206.

Further, the superheater unit 112B receives the steam generated from the first OTC unit 202 and the steam generated from the second OTC unit 206. Further, the superheater unit 112B may receive exhaust gas from the second gas turbine 108. Heat is transferred from the received exhaust gas to the steam in the superheater 112B as well as supplied steam from the first OTC unit 202 and the steam generated from the second OTC unit 206 in the superheater unit 112B. The superheater unit 112B generates the specific steam based on the transferred heat.

In an embodiment, the HRSG unit 112 may include an evaporator unit (not shown in the figure), which evaporates the feedwater entering the HRSG unit 112 by using the heat emitted from the exhaust gas. Thus, a recirculating loop is created, thereby enhancing the efficiency of the energy generation.

Despite the advantages in efficiency and reduced emissions associated with the combined cycle mode, there are several limitations associated with the set of gas turbines working in the combined cycle operating mode and open cycle mode separately. In this configuration, the first gas turbine 104 may operate in the open cycle mode, and the second gas turbine 108 may operate in the combined cycle mode.

To overcome the limitations associated with the gas turbines operating separately in the open cycle operating mode or the combined cycle operating mode, the present disclosure discloses the process of steam sharing in the gas turbines using the heat recovery steam generator (HRSG) unit 112, as described, for example, in FIG. 2C.

FIG. 2C is a diagram that illustrates an exemplary block diagram 200C of the power plant system, where the first gas turbine 104 is operating in the open cycle mode, and the second gas turbine 108 is operating in the combined cycle mode within one or more power blocks. In FIG. 2C, there is shown an exemplary block diagram 200C of the power plant system 102 for steam sharing in the gas turbines using the HRSG unit 112. Elements of FIG. 2C is explained in conjunction with the elements of FIG. 1, FIG. 2A, and FIG. 2B. The power plant system 102 may include the first gas turbine 104, the first compressor unit 106, the first OTC unit 202, the second gas turbine 108, the second compressor unit 110, the second OTC unit 306, a common water header 208, a common steam header 210, the HRSG unit 112, and the set of steam turbines 114. The HRSG unit 112 may further include the economizer unit 112A and the superheater unit 112B.

In an embodiment, the common water header 208 may distribute the feedwater from the HRSG unit 112 to the first OTC unit 202 and the second OTC unit 206. The common water header 208 facilitates efficient management of the feedwater. The common water header 208 may be a piping system that may connect the HRSG unit 112 to the first OTC unit 202 and the second OTC unit 206. In an embodiment, the common water header 208 may be hydraulically connected to the economizer unit 112A associated with the HRSG unit 112. Further, the power plant system 102 may include a control unit that includes one or more processors to control a valve associated with the common water header 208 to receive the feedwater from the HRSG unit 112. The first OTC unit 202 receives the feedwater from the common water header 208 based on the controlled valve. Further, the control unit may control the valve associated with the common water header 208 to receive the feedwater from the HRSG unit 112. The second OTC unit 206 receives the feedwater from the common water header 208 based on the controlled valve. Outlet line between the economiser unit 112A and each OTC unit (e.g., the first OTC unit 104 and the second OTC unit 108) includes a motor-operated isolation valve upstream of the common water header 208. Further, downstream of the common water header 208 includes individual branch lines for feeding each OTC unit, where the individual branch lines are equipped with a motor-operated isolation valve, and a flow-measurement element.

In an embodiment, the common steam header 210 may collect and distribute steam received from the first OTC unit 202 and the second OTC unit 206 to the HRSG unit 112. The common steam header 210 facilitates efficient management of the steam. The common steam header 210 may be a piping system that connects the first OTC unit 202 and the second OTC unit 206 to the HRSG unit 112. A pressure transmitter and a temperature transmitter are associated with the common water header 208 and the common steam header 210 to monitor one or more conditions associated with the common water header 208 and the common steam header 210. Flow of the steam or the feedwater is automatically balanced through a proportional valve that is controlled to maintain uniform pressure and uniform temperature associated with the common water header 208 and the common steam header 210.

In an embodiment, the power plant system 102 may generate energy using the set of gas turbines, including the first gas turbine 104 and the second gas turbine 108. In an embodiment, the first gas turbine 104 may be operating in the open cycle operating mode (for example, 1-0-0 configuration), and the second gas turbine 108 may be operating in conjunction with the HRSG unit 112 in the combined cycle operating mode (for example, 1-1-1 configuration) (intra-block sharing)). Further, the first OTC unit 202 associated with the first gas turbine 104 may supply steam to the HRSG unit 112 associated with the second gas turbine 108. Further, the second OTC unit 206 associated with the second gas turbine 108 may supply steam to the HRSG unit 112. Thereafter, the HRSG unit 112 generates the specific steam based on the steam supplied from the first OTC unit 202 and the steam supplied from the second OTC unit 206. Further, the HRSG unit 112 may supply the specific steam to the set of steam turbines 114. Further, the set of steam turbines 114 may generate energy based on the supply of the specific steam from the HRSG unit 112.

In operation, the power plant system 102 may be configured to execute the process of steam sharing using the HRSG unit 112, which involves supplying the steam by the first OTC unit 202 associated with the first gas turbine 104 to the HRSG unit 112 by using the common steam header 210. Further, the steam is supplied from the second OTC unit 206 associated with the second gas turbine 108 to the HRSG unit 112 by using the common steam header 210. Further, the first OTC unit 202 and the second OTC unit 206 may receive the feedwater from the HRSG unit 112, in the combined cycle operating mode. Additionally, the steam generated in the first OTC unit 202 associated with the first gas turbine 104 may be transferred to the HRSG unit 112 associated with the second gas turbine 108 (instead of sending it to the dump condenser unit 304, as described in FIG. 1 and in FIG. 2A.).

In an embodiment, the first OTC unit 202 may receive the feedwater from the HRSG unit 112. The temperature of the feedwater within the first OTC unit 202 is increased from the first temperature value to the second temperature value based on the received air compressed within the first compressor unit. The steam is generated within the first OTC unit 202 based on the increased temperature of the feedwater. Further, the second OTC unit receives the feedwater from the HRSG unit 112. The temperature of the feedwater within the second OTC unit 206 is increased from the first temperature value to the second temperature value based on the extracted air compressed within the second compressor unit. Furthermore, the steam is generated within the second OTC unit 206 is based on the increased temperature of the feedwater.

In an embodiment, the 2-0-0 configuration includes two gas turbines configured to operate in an open cycle mode. The first OTC unit 202 is associated with the first gas turbine 104. The first OTC unit 202 may be integrated with the dump condenser unit 204. The steam is supplied from the first OTC unit 202 to the dump condenser unit 204. Further, the dump condenser unit 204 condenses the steam received from the first OTC unit 202 to generate feedwater. The generated feedwater is supplied to the first OTC unit 202. A similar process may occur between the second gas turbine 108, the second OTC unit 206, and the dump condenser associated with the second gas turbine 108. Further, the 2-1-1 configuration includes two gas turbines, one HRSG unit 112, and one steam turbine. In the 2-1-1 configuration, the first gas turbine 104 may operate in the open cycle mode, and the second gas turbine may operate in the combined cycle mode. The second OTC unit 206 is associated with the second gas turbine 108. The steam generated within the second OTC unit 206 is supplied to the HRSG unit 112 to generate the specific steam. The HRSG unit 112 may generate the specific steam based on the steam supplied from the second OTC unit 206 to the HRSG unit 112. In a 2-2-1 configuration, the first gas turbine 104 may operate in the open cycle mode. The second gas turbine 108 may operate in the combined cycle mode. In the 2-2-1 configuration, the steam generated within the first OTC unit 202 associated with the first gas turbine 104 is supplied to the HRSG unit 112 associated with the second gas turbine 108.

In an embodiment, two adjacent power blocks (inter-block sharing (cross-block)) are configured as a 2-0-0 configuration and a 2-2-1 configuration, respectively. An active block (with the 2-2-1 configuration) provides the feedwater through the common water header 208 to each OTC of an inactive block (with the 2-0-0 configuration). Further, the active block receives the generated steam from the inactive block via the common steam header 210. Further, the control unit logic ensures that only available HRSGs accept the generated steam, while unconnected OTCs continue to operate with the dump condenser 204. This arrangement extends the efficiency benefits across blocks.

In an embodiment, the power plant system 102 may be arranged in various configurations to optimize performance and operational flexibility of the power plant system 102. Examples include, but are not limited to, configurations such as 2-0-0, 1-1-1, or 3-0-0, wherein the numbers represent the number of the set of gas turbines, the HRSG unit 112, and the set of steam turbines 114, which may be arranged in respective configurations. The respective configurations may enable load distribution, improve efficiency as required by specific operational demands of the power plant system 102.

The process described in the present disclosure applies to the gas turbine combined cycle plants with either OTC units or air-cooling systems that produce steam, especially where the set of gas turbines/HRSG units share a common steam turbine. The disclosed process enhances efficiency in facilities using flexible operations, allowing CC mode and OC mode without typical losses. Further, potential modifications include separate headers for multi-pressure HRSG units, a predictive control algorithm for valve optimization, and compatibility with air-cooled or dry cooling systems. The design supports adaptability while preserving core functionality.

Further, the design ensures safety and isolation through non-return valves that prevent reverse flow between HRSGs, thermal relief valves to guard against overheating during isolation, and manual isolation valves for maintenance activities. The common water header 208 and the common steam header 210 are installed on existing pipe racks with added supports, drains, and vents. Control and communication cabling is integrated into the control unit associated with the power plant system 102. Redundant signal paths are included to enhance operational reliability.

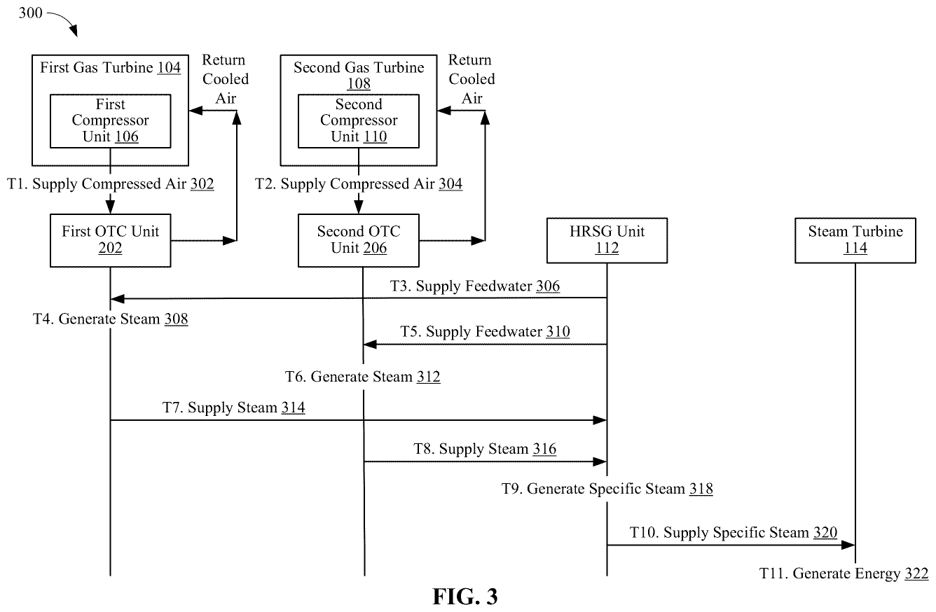

FIG. 3 is an exemplary block diagram 300 that illustrates an exemplary call flow diagram of the power plant system 102 for an integrated OTC water and steam sharing system for multi-unit gas turbine power blocks, in accordance with the present disclosure. FIG. 3 is explained in conjunction with FIG. 1, FIG. 2A, FIG. 2B, and FIG. 2C. With reference to FIG. 3, the exemplary block diagram 300 illustrates exemplary steps from 304 to 324, as described herein. The exemplary operations illustrated in the exemplary block diagram 300 may start at 304 and may be performed by any apparatus or device, such as by the power plant system 102 of FIG. 1. Although illustrated with discrete blocks, the exemplary operations associated with one or more blocks of the exemplary block diagram 300 may be divided into additional blocks, combined into fewer blocks, or eliminated, depending on the implementation.

At 304, the first compressor unit 106 may initiate the operation of the power plant system 102 by supplying the extracted compressed air to the first OTC unit 202. In an embodiment, the first compressor unit 106 may initiate the operation of the power plant system 102 at a timestamp corresponding to “T1”. In an embodiment, the first compressor unit 106 may be configured to receive air from the air filtration unit. Further, the first compressor unit 106 may compress the received air and supply the compressed air to the first compressor unit 106. Furthermore, the first OTC unit 202 may receive the extraction air, which may be compressed within the first compressor unit 106.

At 306, the second compressor unit 110 may initiate the operation of the power plant system 102 by supplying the compressed air to the second OTC unit 206. In an embodiment, the second compressor unit 110 may initiate the operation of the power plant system 102 at the timestamp corresponding to “T2”. In an embodiment, the second compressor unit 110 may be configured to receive air from the air filtration unit. Further, the second compressor unit 110 may compress the received air and supply the compressed air to the second OTC unit 206. Furthermore, the second OTC unit 206 may receive the extracted compressed air, which may be compressed within the second OTC unit 206.

At 308, the HRSG unit 112 may supply the feedwater to the first OTC unit 202. In an embodiment, the HRSG unit 112 may supply the feedwater to the first OTC unit 202 at the timestamp corresponding to “T3”.

At 310, the first OTC unit 202 may generate the steam based on the supplied feedwater from the HRSG unit 112 and the extracted compressed air received from the first compressor unit 106. In an embodiment, the first OTC unit 202 may generate the steam at the timestamp corresponding to “T4”.

At 312, the HRSG unit 112 may supply the feedwater to the second OTC unit 206. In an embodiment, the HRSG unit 112 may supply the feedwater to the second OTC unit 206 at the timestamp corresponding to “T5”.

At 314, the second OTC unit 206 may generate the steam based on the supplied feedwater from the HRSG unit 112 and the extracted compressed air received from the second compressor unit 110. In an embodiment, the second OTC unit 206 may generate the steam at the timestamp corresponding to “T6”.

At 316, the first OTC unit 202 may supply the steam to the HRSG unit 112. The HRSG unit 112 is associated with the second gas turbine 108. In an embodiment, the first OTC unit 202 may supply the steam to the HRSG unit 112 at the timestamp corresponding to “T7”.

At 318, the second OTC unit 206 may supply the steam to the HRSG unit 112. In an embodiment, the second OTC unit 206 may supply the steam to the HRSG unit 112 at the timestamp corresponding to “T8”. In an embodiment, the second OTC unit 206 may supply of steam from the second OTC unit 306 associated with the second gas turbine 108 to the HRSG unit 112.

At 320, the HRSG unit 112 may generate the specific steam based on the steam supplied from the first OTC unit 202 and the second OTC unit 206. In an embodiment, the HRSG unit 112 may generate the specific steam at the timestamp corresponding to “T9”.

At 322, the HRSG unit 112 may supply the specific steam to the set of steam turbines 114. In an embodiment, the HRSG unit 112 may supply the specific steam at the timestamp corresponding to “T10”.

At 324, the set of steam turbines 114 may generate energy based on the supplied specific steam from the HRSG unit 112. In an embodiment, the set of steam turbines 114 may generate energy at the timestamp corresponding to “T11”.

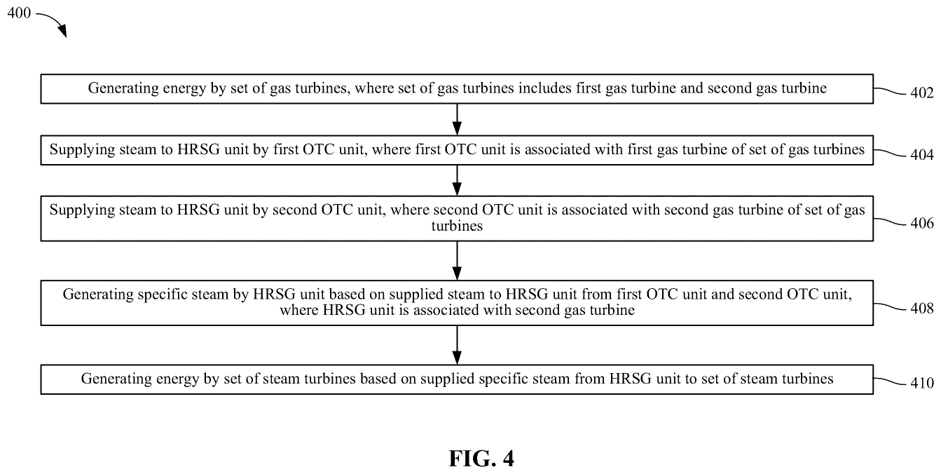

FIG. 4 illustrates a flowchart 400 of an exemplary method for the power plant system 102, in accordance with an embodiment of the disclosure. FIG. 4 is explained in conjunction with elements from FIG. 1, FIG. 2A, FIG. 2B, FIG. 2C and FIG. 3. The operations of the exemplary method may be executed for the power plant system 102 of FIG. 1.

At operation 402, the operations of the flowchart 400 may include generating, by the set of gas turbines, exhaust energy, where the set of gas turbines comprises the first gas turbine 104 and the second gas turbine 108. Details about the generation of the energy by the set of gas turbines are provided in FIG. 2A, FIG. 2B, FIG. 2C, and FIG. 3.

At operation 404, the operations of the flowchart 400 may include supplying, by the first OTC unit 202 to the HRSG unit 112, steam, where the first OTC unit 202 is associated with the first gas turbine 104 of the set of gas turbines. The first gas turbine 104 is in the open cycle mode. Details about the supplying steam by the first OTC unit 202 to the HRSG unit 112 are provided in FIG. 2A, FIG. 2B, FIG. 2C, and FIG. 3.

At operation 406, the operations of the flowchart 400 may include supplying, by the second OTC unit 206 to the HRSG unit 112, steam, where the second OTC unit 206 is associated with the second gas turbine 108 of the set of gas turbines. The second gas turbine 108 is in the combined cycle mode. Details about the supplying steam by the first OTC unit 202 to the HRSG unit 112 are provided in FIG. 2A, FIG. 2B, FIG. 2C, and FIG. 3.

At operation 408, the operations of the flowchart 400 may include generating, by the HRSG unit 112, specific steam based on the steam supplied to the HRSG unit 112 from the first OTC unit 202 and the steam supplied to the HRSG unit 112 from the second OTC unit 206. The HRSG unit 112 is associated with the second gas turbine 108. Details about the include generating energy by the set of gas turbines, are provided in FIG. 2A, FIG. 2B, FIG. 2C, and FIG. 3.

At operation 410, the operations of the flowchart 400 may include generating, by the set of steam turbines 114, energy based on the generated specific steam. The generated specific steam is supplied from the HRSG unit 112 to the set of steam turbines 114. Details about the control of the set of steam turbines 114 are provided in FIG. 2A, FIG. 2B, FIG. 2C, and FIG. 3.

While the above steps shown in FIG. 4 are described in a particular sequence, the steps may occur in variations to the sequence in accordance with various embodiments of the present disclosure. Further, details related to various steps of FIG. 4, which are already covered in the description related to FIGS. 1, 2A, FIG. 2B, FIG. 2C, and FIG. 3 are not discussed again in detail here for the sake of brevity

Alternatively, the power plant system 102 may comprise means for performing each of the operations described above. According to an example embodiment, examples of means for performing operations may comprise, for example, the processor and/or a device or circuit for executing instructions or executing an algorithm for processing information as described above.

In an embodiment, the power plant system 102 includes the set of gas turbines. The set of gas turbines includes the first gas turbine 104 operating in the open cycle mode and the second gas turbine 108 operating in the combined cycle mode. The first gas turbine 104 and the second gas turbine 108 are configured to generate energy. Further, the power plant system 102 includes the first OTC unit 202 associated with the first gas turbine 104, where steam is supplied from the first OTC unit 202. Further, the power plant system 102 includes the second OTC unit 206 associated with the second gas turbine 108, where steam is supplied from the second OTC unit 206. Further, the power plant system 102 includes the HRSG unit 112 associated with the second gas turbine 108, where the steam is supplied to the HRSG unit 112 from the first OTC unit 202 and the second OTC unit 206 to generate specific steam. Further, the power plant system 102 includes the set of steam turbines 114 that generate energy based on a supply of the specific steam from the HRSG unit 112 to the set of steam turbines 114.

In an embodiment, the power plant system 102 further includes the common steam header 210 and a control unit. The control unit includes one or more processors configured to control a valve associated with the common steam header 210 to receive at least the steam from the first OTC unit 104 and the steam from the second OTC unit 206. The HRSG unit 112 associated with the second gas turbine 108 receives at least the steam from the first OTC unit 202 and the steam from the second OTC unit 206 from the common steam header 210. The at least the steam from the first OTC unit 202 and the steam from the second OTC unit 206 is received based on the controlled valve.

In an embodiment, the power plant system 102 further includes the set of compressor units associated with the set of gas turbines. The set of compressor units includes at least the first compressor unit 106 associated with the first OTC unit 202 and the second compressor unit 110 associated with the second OTC unit 206. The set of compressor units extracts air from an air filtration unit. The set of compressor units compresses the air, and some portion of air is being extracted from various stages of the compressor, which is being fed to the first OTC unit 202. The first OTC unit 202 receives the extracted air from the first compressor unit 106 and compressed within the first compressor unit 106. The second OTC unit 206 receives the extracted air from the second compressor unit 110 and compressed within the second compressor unit 110.

In an embodiment, the first OTC unit 202 receives feedwater from the HRSG unit 112. Further, a temperature of the feedwater within the first OTC unit 202 is increased from a first temperature value to a second temperature value based on the received air compressed within the first compressor unit 106. The steam is generated within the first OTC unit 202 based on the increased temperature of the feedwater.

In an embodiment, the power plant system 102 further includes the common water header 208 and a control unit. The control unit, including one or more processors configured to control a valve associated with the common water header 208 to receive the feedwater from the HRSG unit 112. The first OTC unit 202 receives the feedwater from the common water header 208 based on the controlled valve.

In an embodiment, the second OTC unit 206 receives feedwater from the HRSG unit 114. Further, a temperature of the feedwater within the second OTC unit 206 is increased from a first temperature value to a second temperature value based on the received extracted air compressed within the second compressor unit 110. The steam is generated within the second OTC unit 206 based on the increased temperature of the feedwater.

In an embodiment, the power plant system 102 further includes the common water header 208 and a control unit. The control unit, including one or more processors configured to control a valve associated with the common water header 208 to receive the feedwater from the HRSG unit 112. The second OTC unit 206 receives the feedwater from the common water header 208 based on the controlled valve.

In an embodiment, the HRSG unit 112 includes the economizer unit 112A configured to receive exhaust gases from the set of gas turbines 114. The economizer unit 112A extracts heat from the received exhaust gases. The economizer unit 112A transfers the extracted heat to feedwater associated with the economizer unit 112A. The transferred extracted heat increases the temperature of the feedwater from the first temperature value to the second temperature value. The economizer unit 112A transfers the feedwater at the second temperature value to the common water header 208 associated with at least the first OTC unit 202 and the second OTC unit 206.

In an embodiment, the HRSG unit 112 includes the superheater unit 112B. The superheater unit 112B receives the steam supplied from the first OTC unit 202 and the steam supplied from the second OTC unit 206. The superheater unit 112B receives exhaust gas from the second gas turbine 108. The superheater unit 112B transfers heat from the received exhaust gas to the steam supplied from the first OTC unit 202 and the steam supplied from the second OTC unit 206 to the steam within the superheater unit 112B. The superheater unit 112B generates the specific steam based on the transferred heat.

In an embodiment, the first gas turbine 104 is configured to operate in the open cycle mode. The first OTC unit 202 is associated with the first gas turbine 104. The first OTC unit 202 is integrated with the dump condenser unit 204. The steam is supplied from the first OTC unit 202 to the dump condenser unit 204. The dump condenser unit condenses the steam received from the first OTC unit 202 to generate feedwater, where the generated feedwater is supplied to the first OTC unit 202.

In an embodiment, the second gas turbine 108 is configured to operate in the combined cycle mode. The second OTC unit 206 is associated with the second gas turbine 108. The steam generated within the second OTC unit 206 is supplied to the HRSG unit. The HRSG unit generates the specific steam. The HRSG unit generates the specific steam based on the steam supplied from the second OTC unit 206 to the HRSG unit.

In another aspect, a method of operating a power plant system 102 includes the set of gas turbines, the first OTC unit 202, the second OTC unit, the HRSG unit 112, and the set of steam turbines 114 is provided. The method may include supplying, by the first OTC unit 202 to the HRSG unit 112, steam to the HRSG unit 112. The first OTC unit 202 is associated with the first gas turbine 104 of the set of gas turbines, and where the first gas turbine 104 is in the OC mode. The method may include supplying, by the second OTC unit 206 to the HRSG unit, steam to the HRSG unit. The second OTC unit 206 is associated with the second gas turbine 108 of the set of gas turbines, and where the second gas turbine 108 is operating in the combined cycle mode. The method may include generating, by the set of gas turbines, the energy, where the set of gas turbines includes the first gas turbine 104 and the second gas turbine 108. The method may include generating, by the HRSG unit, the specific steam based on the steam supplied to the HRSG unit from the first OTC unit 202 and the steam supplied to the HRSG unit from the second OTC unit 206. The HRSG unit is associated with the second gas turbine 108. The method may include generating, by the set of steam turbines, the energy based on the generated specific steam, where the generated specific steam is supplied from the HRSG unit to the set of steam turbines.

In an embodiment, the power plant system 102 further includes the common steam header 210, and the control unit includes the one or more processors. The method further includes controlling, by the one or more processors, the valve associated with the common steam header 210 to receive the at least the steam from the first OTC unit 202 and the steam from the second OTC unit 206. The HRSG unit associated with the second gas turbine 108 receives the at least the steam from the first OTC unit 202 and the steam from the second OTC unit 206 from the common steam header 210. The at least the steam from the first OTC unit 202 and the steam from the second OTC unit 206 is received based on the controlling of the valve.

In an embodiment, the power plant system 102 further includes the set of compressor units associated with the set of gas turbines. The set of compressor units includes at least the first compressor unit 106 associated with the first OTC unit 202 and the second compressor unit 110 associated with the second OTC unit 206. The method further includes extracting, by the set of compressor units, air from the air filtration unit. The method further includes compressing, by the set of compressor units, the air, and some portion of air is being extracted from various stages of compressor, which is being fed to the first OTC unit 202 from the first compressor unit 106, and the extracted air compressed within the first compressor unit 106. The method further includes receiving, by the second OTC unit 206 from the second compressor unit 110, the extracted air compressed within the second compressor unit 110.

In an embodiment, the method may include receiving, by the first OTC unit 202, feedwater from the HRSG unit. A temperature of the feedwater within the first OTC unit 202 is increased from the first temperature value to the second temperature value based on the received air compressed within the first compressor unit 106. The steam is generated within the first OTC unit 202 based on the increased temperature of the feedwater.

In an embodiment, the power plant system further includes a common water header 208, and a control unit includes the one or more processors. The method further includes controlling, by the one or more processors, the valve associated with the common water header 208 to receive the feedwater from the HRSG unit. The first OTC unit 202 receives the feedwater from the common water header 208 based on the controlling of the valve.

In an embodiment, the method may include receiving, by the second OTC unit 206, feedwater from the HRSG unit. The temperature of the feedwater within the second OTC unit 206 is increased from the first temperature value to the second temperature value based on the received extracted air compressed within the second compressor unit 110. The steam is generated within the second OTC unit 206 based on the increased temperature of the feedwater.

In an embodiment, the power plant system 102 further includes the common water header 208 and the control unit includes one or more processors. The method further includes controlling, by the one or more processors, a valve associated with a common water header 208 to receive the feedwater from the HRSG unit. The second OTC unit 206 receives the feedwater from the common water header 208 based on the controlling of the valve.

In an embodiment, the method may include receiving, by the HRSG unit, exhaust gases from the second gas turbine 108. The HRSG unit includes the economizer unit 112A, where the economizer unit 112A extracts heat from the received exhaust gases. The economizer unit 112A transfers the extracted heat to the feedwater associated with the economizer unit 112A. The transferred extracted heat increases the temperature of the feedwater from a first temperature value to a second temperature value, and where the economizer unit 112A transfers the feedwater at the second temperature value to the common water header 208 associated with at least the first OTC unit 202 and the second OTC unit 206.

In an embodiment, the method may include receiving, by a superheater unit 112B, the steam supplied from the first OTC unit 202 and the steam supplied from the second OTC unit 206. The HRSG unit includes the superheater unit 112B, where the superheater unit 112B receives exhaust gas from the second gas turbine 108. The superheater unit 112B transfers heat from the received exhaust gas to the steam supplied from the first OTC unit 202 and the steam supplied from the second OTC unit 206, and where the superheater unit 112B generates the specific steam based on the transferred heat.

Many modifications and other embodiments of the inventions set forth herein will come to mind to one skilled in the art to which these inventions pertain, having the benefit of the teachings presented in the foregoing descriptions and the associated drawings. Therefore, it is to be understood that the inventions are not to be limited to the specific embodiments disclosed and that modifications and other embodiments.

Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the invention. In this regard, for example, different combinations of reactants and/or functions than those explicitly described above are also contemplated. Although specific terms are employed herein, they are used in a generic and descriptive sense only and not for purposes of limitation.

What is claimed:

1. A power plant system comprising:
a set of gas turbines comprising a first gas turbine operating in an open cycle mode and a second gas turbine operating in a combined cycle mode, wherein the first gas turbine and the second gas turbine are configured to generate energy;
a first once-through cooling (OTC) unit associated with the first gas turbine, wherein steam is supplied from the first OTC unit;
a second once-through cooling (OTC) unit associated with the second gas turbine, wherein steam is supplied from the second OTC unit;
a heat recovery steam generator (HRSG) unit associated with the second gas turbine, wherein the steam is supplied to the HRSG unit from the first OTC unit and the second OTC unit to generate specific steam; and
a set of steam turbines to generate energy based on a supply of the specific steam from the HRSG unit to the set of steam turbines.

2. The power plant system of claim 1, wherein the power plant system further comprising:
a common steam header; and
a control unit comprising one or more processors configured to:
control a valve associated with the common steam header to receive at least the steam from the first OTC unit and the steam from the second OTC unit, wherein the HRSG unit associated with the second gas turbine receives, from the common steam header, at least the steam from the first OTC unit and the steam from the second OTC unit, and wherein the at least the steam from the first OTC unit and the steam from the second OTC unit is received based on the controlled valve.

3. The power plant system of claim 1, wherein the power plant system further comprising:
a set of compressor units associated with the set of gas turbines, wherein the set of compressor units comprises at least a first compressor unit associated with the first OTC unit and a second compressor unit associated with the second OTC unit,
the set of compressor units receives air from an air filtration unit,
the set of compressor units compresses the air, and some portion of air is being extracted from various stages of compressor, which is being fed to the OTC unit,
the first OTC unit receives, from the first compressor unit, the extracted air compressed within the first compressor unit, and
the second OTC unit receives, from the second compressor unit, the extracted air compressed within the second compressor unit.

4. The power plant system of claim 3, wherein:
the first OTC unit receives feedwater from the HRSG unit,
a temperature of the feedwater within the first OTC unit is increased from a first temperature value to a second temperature value based on the received air compressed within the first compressor unit, and
the steam is generated within the first OTC unit based on the increased temperature of the feedwater.

5. The power plant system of claim 4, wherein the power plant system further comprising:
a common water header; and
a control unit comprising one or more processors configured to:
control a valve associated with the common water header to receive the feedwater from the HRSG unit, wherein the first OTC unit receives the feedwater from the common water header based on the controlled valve.

6. The power plant system of claim 3, wherein:
the second OTC unit receives feedwater from the HRSG unit,
a temperature of the feedwater within the second OTC unit is increased from a first temperature value to a second temperature value based on the received extracted air compressed within the second compressor unit, and
the steam is generated within the second OTC unit based on the increased temperature of the feedwater.

7. The power plant system of claim 6, wherein the power plant system further comprising:
a common water header; and
a control unit comprising one or more processors configured to:
control a valve associated with a common water header to receive the feedwater from the HRSG unit, wherein the second OTC unit receives the feedwater from the common water header based on the controlled valve.

8. The power plant system of claim 1, wherein:
the HRSG unit comprising an economizer unit configured to receive exhaust gases from the second gas turbine,
the economizer unit extracts heat from the received exhaust gases,
the economizer unit transfers the extracted heat to feedwater associated with the economizer unit,
the transferred extracted heat increases temperature of the feedwater from a first temperature value to a second temperature value, and
the economizer unit transfers the feedwater at the second temperature value to a common water header associated with at least the first OTC unit and the second OTC unit.

9. The power plant system of claim 1, wherein:
the HRSG unit comprises a superheater unit,
the superheater unit receives the steam supplied from the first OTC unit and the steam supplied from the second OTC unit,
the superheater unit receives exhaust gas from the second gas turbine,
the superheater unit transfers heat from the received exhaust gas to the steam supplied by the first OTC unit and the steam supplied from the second OTC unit to steam within the superheater unit, and
the superheater unit generates the specific steam based on the transferred heat.

10. The power plant system of claim 1, wherein the first gas turbine is configured to operate in an open cycle mode,
the first OTC unit is associated with the first gas turbine,
the first OTC unit is integrated with a condenser unit,
the steam is supplied from the first OTC unit to the condenser unit; and
the condenser unit condenses the steam received from the first OTC unit to generate feedwater, wherein the generated feedwater is supplied to the first OTC unit.

11. The power plant system of claim 1, wherein the second gas turbine is configured to operate in a combined cycle mode,
the second OTC unit is associated with the second gas turbine,
the steam generated within the second OTC unit is supplied to the HRSG unit; and
the HRSG unit generates the specific steam, wherein the HRSG unit generates the specific steam based on the steam supplied from the second OTC unit to the HRSG unit.

12. A method of operating a power plant system comprising a set of gas turbines, a first once-through cooling (OTC) unit, a second once-through cooling (OTC) unit, a heat recovery steam generator (HRSG) unit and a set of steam turbines, wherein the method comprising:
supplying, by the first OTC unit to the HRSG unit, steam, wherein the first OTC unit is associated with a first gas turbine of the set of gas turbines, and wherein the first gas turbine is in an open cycle mode;
supplying, by the second OTC unit to the HRSG unit, steam, wherein the second OTC unit is associated with a second gas turbine of the set of gas turbines, and wherein the second gas turbine is operating in a combined cycle mode;
generating, by the set of gas turbines, energy, wherein the set of gas turbines comprises the first gas turbine and the second gas turbine;
generating, by the HRSG unit, specific steam based on the steam supplied to the HRSG unit from the first OTC unit and the steam supplied to the HRSG unit from the second OTC unit, wherein the HRSG unit is associated with the second gas turbine; and
generating, by the set of steam turbines, energy based on the generated specific steam, wherein the generated specific steam is supplied from the HRSG unit to the set of steam turbines.

13. The method of claim 12, wherein the power plant system further comprises a common steam header and a control unit comprising one or more processors, and wherein the method further comprises:
controlling, by the one or more processors, a valve associated with the common steam header to receive at least the steam from the first OTC unit and the steam from the second OTC unit, wherein the HRSG unit associated with the second gas turbine receives, from the common steam header, the at least the steam from the first OTC unit and the steam from the second OTC unit, and wherein the at least the steam from the first OTC unit and the steam from the second OTC unit is received based on the controlling of the valve.

14. The method of claim 12, wherein the power plant system further comprises a set of compressor units associated with the set of gas turbines, wherein the set of compressor units comprises at least a first compressor unit associated with the first OTC unit and a second compressor unit associated with the second OTC unit, and wherein the method further comprising:
extracting, by the set of compressor units, air from an air filtration unit;
compressing, by the set of compressor units, the extracted air and some portion of air is being extracted from various stages of compressor which is being fed to the first OTC unit;
receiving, by the first OTC unit from the first compressor unit, the extracted air compressed within the first compressor unit; and
receiving, by the second OTC unit from the second compressor unit, the extracted air compressed within the second compressor unit.

15. The method of claim 14, further comprising:
receiving, by the first OTC unit, feedwater from the HRSG unit, wherein
a temperature of the feedwater within the first OTC unit is increased from a first temperature value to a second temperature value based on the received air compressed within the first compressor unit, and
the steam is generated within the first OTC unit based on the increased temperature of the feedwater.

16. The method of claim 15, wherein the power plant system further comprises a common water header and a control unit comprising one or more processors, and wherein the method further comprising:
controlling, by the one or more processors, a valve associated with the common water header to receive the feedwater from the HRSG unit, wherein the first OTC unit receives the feedwater from the common water header based on the controlling of the valve.

17. The method of claim 14, further comprising:
receiving, by the second OTC unit, feedwater from the HRSG unit, wherein a temperature of the feedwater within the second OTC unit is increased from a first temperature value to a second temperature value based on the received extracted air compressed within the second compressor unit, and wherein the steam is generated within the second OTC unit based on the increased temperature of the feedwater.

18. The method of claim 17, wherein the power plant system further comprises a common water header and a control unit comprising one or more processors, and wherein the method further comprising:
controlling, by the one or more processors, a valve associated with a common water header to receive the feedwater from the HRSG unit, wherein the second OTC unit receives the feedwater from the common water header based on the controlling of the valve.

19. The method of claim 12, further comprising:
receiving, by the HRSG unit, exhaust gases from the second gas turbine, wherein the HRSG unit comprises an economizer unit, wherein the economizer unit extracts heat from the received exhaust gases, wherein the economizer unit transfers the extracted heat to feedwater associated the economizer unit, wherein the transferred extracted heat increases temperature of the feedwater from a first temperature value to a second temperature value, and wherein the economizer unit transfers the feedwater at the second temperature value to a common water header associated with at least the first OTC unit and the second OTC unit.

20. The method of claim 12, further comprising:
receiving, by a superheater unit, the steam supplied from the first OTC unit and the steam supplied from the second OTC unit, wherein the HRSG unit comprises the superheater unit, wherein the superheater unit receives exhaust gas from the second gas turbine, wherein the superheater unit transfers heat from the received exhaust gas to the steam supplied from the first OTC unit and the steam supplied from the second OTC unit, and wherein the superheater unit generates the specific steam based on the transferred heat.
